(19) United States
(12) Patent Application Publication
(10) Pub. No.: US 2008/0075910 A1
(43) Pub. Date: Mar. 27, 2008

(54) OPTICAL INFORMATION RECORDING MEDIA WITH EXCELLENT DURABILITY

(75) Inventors: Takeshi OHWAKI, Kobe-shi (JP); Takayuki Tsubota, Kobe-shi (JP); Hideo Fujii, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd), Kobe-shi (JP)

(21) Appl. No.: 11/830,150

(22) Filed: Jul. 30, 2007

(30) Foreign Application Priority Data
Sep. 22, 2006 (JP) 2006-257532

(51) Int. Cl. B32B 3/02

(52) U.S. Cl. 428/65.1

(57) ABSTRACT

Disclosed is an optical information recording medium which includes at least one substrate, at least one thin film of silver or a silver alloy, and an ultraviolet-cured resin layer, in which the at least one thin film and the ultraviolet-cured resin layer are in contact with each other and are arranged on or above the at least one substrate. In the recording medium, the ultraviolet-cured resin layer contains a cured resin of at least one acrylic monomer cured by the action of ultraviolet rays, and this ultraviolet-cured resin layer has a content of a resin-derived organic component of 99 percent by mass or more and has a surface electrical resistance of 2.0×10¹³Ω or more.

### BACKGROUND OF THE INVENTION

1. Field of the Invention

The present invention relates to optical information recording media which are used as optical recording media such as DVDs (digital versatile discs) and are excellent in durability such as light resistance. The optical information recording media are suitable typically as high-capacity optical information recording media which have a recording capacity of 10 gigabytes or more per disc and require such excellent durability.

The term “thin film” as used herein refers to a thin film of silver (Ag; pure silver) or a silver alloy for use as a reflective film or a semi-reflective film (semi-translucent reflective film) in optical information recording media. Such a reflective film and a semi-reflective film are also generically referred to as a “reflective film”, and silver and a silver alloy is also generically referred to as a “silver alloy” hereinafter.

2. Description of the Related Art

Improvements in durability are still a basic technological task in optical discs each including a substrate, a thin film of silver or a silver alloy, and an ultraviolet-cured resin layer, in which the thin film and the ultraviolet-cured resin layer are in contact with each other and arranged on or above the substrate The wavelength of readout signals in known optical discs is 650 nm, but that of next-generation optical discs (Blu-ray Discs and HD-DVDS) is as short as of 405 nm. Such a shorter wavelength of readout signals causes reduction in reflectivity of optical discs and reduction in period (lifetime) of optical discs until the optical discs become incapable of reading out signals.

Specifically, assuming that thin films of silver or a silver alloy and ultraviolet-cured resin layers in optical discs deteriorate to the same extent at the interfaces between them, an optical disc having a readout wavelength of 405 nm shows a more decreased reflectivity and a shorter period until it becomes incapable of reading out signals, than an optical disc having a readout wavelength of 650 nm. The optical disc becomes incapable of reproducing signals at the time when its reflective film has a reflectivity lower than such a lower limit as to detect reproduced signals.

As a possible solution to this, there have been made improvements in the silver reflective film, such as the deposition of a reflective film from a silver alloy, or improvements in the ultraviolet-cured resin layer.

As improvements in the ultraviolet-cured resin layer, there have been predominantly proposed improvements in surface electrical resistance of the ultraviolet-cured resin layer. Japanese Unexamined Patent Application Publication (JP-A) No. 2004-175866, for example, proposes a resin composition for an ultraviolet-cured resin layer which contains an acrylic monomer (acrylate monomer) and has an electric resistivity at 25° C. of 1000 MΩ.cm or less before ultraviolet curing.

Japanese Unexamined Patent Application Publication (JP-A) No. 2005-166075 proposes an ultraviolet-curable ink for an ultraviolet-cured resin layer which contains a large amount of a pigment. The resulting resin layer after ultraviolet curing has a surface electrical resistance of 1.0×10¹³Ω or more.

### SUMMARY OF THE INVENTION

The technique disclosed in JP-A No. 2004-175866 specifies the electric resistivity of the resin composition before ultraviolet curing. However, the durability of an ultraviolet-curable resin varies depending not on resin properties before ultraviolet curing but on those after ultraviolet curing, and such resin properties after ultraviolet curing vary depending on ultraviolet curing conditions. Accordingly, the technique disclosed in JP-A No. 2004-175866 may not reliably improve the durability of an optical disc.

In this regard, the technique disclosed in JP-A No. 2005-166075 specifies the surface electrical resistance of the ultraviolet-cured resin layer to be 1.0×10¹³Ω or more to increase the hardness and density of the ultraviolet-cured resin layer, in order to improve the durability of the optical disc. The intention to increase the hardness and density of an ultraviolet-cured resin layer may act to suppress the deterioration due to migration and aggregation of silver from the silver alloy reflective film to the ultraviolet-cured resin layer so as to improve the durability of the optical disc.

However, the technique disclosed in JP-A No. 2005-166075 uses an ultraviolet-curable ink containing a large amount of a pigment so as to increase the hardness and density of the ultraviolet-cured resin layer. The use of such a large amount of a pigment sacrifices optical transparency that is essentially required for a resin layer of an optical recording medium. Accordingly, it is difficult to apply the technique to such optical information recording media requiring excellent optical transparency.

Under these circumstances, it is desirable to provide an optical information recording medium having ensured or improved excellent durability.

Specifically, according to an embodiment of the present invention, there is provided an optical information recording medium which contains at least one substrate, at least one thin film containing silver or a silver alloy, and an ultraviolet-cured resin layer, in which the at least one thin film and the ultraviolet-cured resin layer are in contact with each other and are arranged on or above the at least one substrate. In the medium, the ultraviolet-cured resin layer contains a cured resin of at least one acrylic monomer cured by the action of ultraviolet rays, the ultraviolet-cured resin layer has a content of a resin-derived organic component of 99 percent by mass or more, and the ultraviolet-cured resin layer has a surface electrical resistance of 2.0×10¹³Ω or more.

More specifically, the optical information recording medium desirably has such durability as to have a loss in reflectivity after irradiation of 3% or less, in which the irradiation is carried out by applying radiation from a fluorescent lamp having a color temperature of 6700 K to a test piece of the optical information recording medium at a distance of 60 mm at a temperature of 25° C. for 100 hours, and the test piece has substantially the same layer structure as that of the optical information recording medium. Namely, the test piece may include a silver or silver alloy thin film and an ultraviolet-cured resin layer in contact with each other and arranged on a substrate.

According to an embodiment of the present invention, the resin purity of the ultraviolet-cured resin layer is set as high as of 99 percent by mass or more, and, in addition, the hardness and density of the ultraviolet-cured resin layer is increased by the incorporation of an acrylic monomer or by the application of ultraviolet rays at high power.

Specifically, an ultraviolet-cured resin layer can have an increased surface electrical resistance of 2.0×10¹³Ω or more by using a resin composition containing an acrylic monomer as a resin composition before ultraviolet curing, and containing a resin as a cured article of the acrylic monomer cured by ultraviolet irradiation. Alternatively or in addition, an ultraviolet-cured resin layer can have an increased surface electrical resistance of 2.0×10¹³Ω or more by curing a resin composition by irradiation with ultraviolet rays at a high power.

The deterioration due to migration and aggregation of silver from the silver alloy reflective film to the ultraviolet-cured resin layer is suppressed by increasing the surface electrical resistance of the ultraviolet-cured resin layer to 2.0×10¹³Ω or more, so as to improve the hardness and density of the ultraviolet-cured resin layer. This suppresses increase in surface roughness, occurrence of discontinuous film, decrease in reflectivity, and deterioration in functions as a reflective film, each due to the aggregation of silver in the ultraviolet-cured resin layer.

This enables the improvements or insurance of durability, such as light resistance, of the ultraviolet-cured resin layer in an optical information recording medium.

### BRIEF DESCRIPTION OF THE DRAWINGS

FIG. 1 is a schematic view showing the sectional structure of a read-only optical disc.

### DETAILED DESCRIPTION OF THE PREFERRED EMBODIMENTS

Certain embodiments as well as desired conditions according to the present invention will be sequentially illustrated below.

Optical Information Recording Media

Optical information recording media to which embodiments of the present invention are applied will be illustrated. The term “optical information recording media” herein means, as a presumption, optical discs. Such optical discs can be categorized into several types, and are categorized by the writing/reading system into three main types, i.e., read-only, write-once, and rewritable optical discs.

Among them, read-only optical discs are structurally prepared by forming convex and concave recording pits to form recording data on an optically transparent plastic (optically transparent resin) substrate, such as a polycarbonate substrate; and then depositing a silver alloy reflective film on the recording data on the substrate. The substrate for use in the present invention can be a substrate of a resin such as a polycarbonate, as well as a substrate of another substance such as glass, aluminum, or carbon.

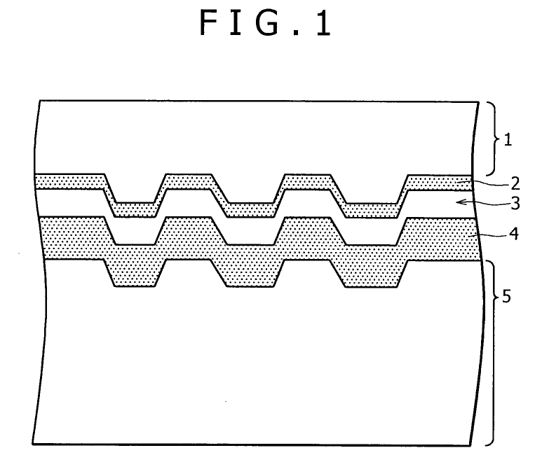

FIG. 1 is a schematic view showing an example of the sectional structure of such a read-only optical disc. The read-only optical disc in FIG. 1, to which an embodiment of the present invention is applied, includes polycarbonate substrates 1 and 5, a silver alloy semi-reflective film 2, an ultraviolet-curable resin adhesive layer 3, and a silver alloy total-reflective film 4.

In the read-only optical disc, data readout is carried out by detecting the phase difference or reflectance difference of laser beams applied to the disc. In the sectional structure, a partial structure including the optically transparent plastic (polycarbonate) substrate 5 and the reflective film 4 arranged on the substrate 5 is manufactured by depositing a silver alloy on the polycarbonate substrate 5 bearing respective recording pits to form the reflective film 4, and applying an ultraviolet (UV) curable resin to the reflective film 4 by spin coating to form the resin layer 3.

The optical disc shown in FIG. 1 is a double-layer optical disc in which data are recorded in and read out from two layers. This double-layer optical disc includes the above-mentioned partial structure, and another optically transparent plastic substrate 1 bearing a semi-reflective film 2. With reference to FIG. 1, this optical disc is prepared by depositing a silver alloy film on a polycarbonate substrate 1 to form a semi-reflective film 2 thereon, and bonding the semi-reflective film 2 to the silver alloy total-reflective film 4 on the polycarbonate substrate 5 with the interposition of the ultraviolet-curable resin layer.

Durability

Optical information recording media (optical discs) to which some embodiments of the present invention are applied are categorized into several types as mentioned above. In any type, the optical discs preferably have light resistance at a certain level or higher, as measured under the specific test conditions with reproducibility. The light resistance herein is an index (basis or property) of practical durability. An index of the light resistance and measuring conditions with reproducibility in the durability test will be illustrated below.

Light Resistance Evaluation Test

Tests for evaluating light resistance as an index of durability in the present invention should be carried out under one common condition regardless of the types of optical information recording media, for providing satisfactory reproducibility. By carrying out tests under the one common condition, the light resistance can be applied with good reproducibility as a criterion for optical information recording media (optical disc) to which some embodiments of the present invention are applied. This is also true for the after-mentioned tests for evaluating resistance to moist heat.

Light resistance evaluation tests for use in the present invention are carried out by applying radiation (light) from a fluorescent lamp having a color temperature of 6700 K to an optical information recording medium, measuring the reflectivity of the optical information recording medium before and after irradiation, and evaluating the loss in reflectivity after irradiation. The optical information recording medium used herein includes a substrate, a silver or a silver alloy thin film, and an ultraviolet-cured resin layer, in which the silver or a silver alloy thin film and the ultraviolet-cured resin layer are in contact with each other and are arranged on the substrate.

For practical use, a silver or a silver alloy thin film or an optical information recording medium preferably has a loss in reflectivity after the irradiation of 3% or less.

The light resistance tests should be carried out under a specific condition for satisfactory reproducibility. Specifically, the tests should be carried out by applying radiation from a fluorescent lamp having a color temperature of 6700 K to the test optical disc (optical information recording medium) at a predetermined distance of 60 mm at a testing temperature (atmosphere temperature) of 25° C. for an irradiation period of the fluorescent lamp of 100 hours.

Then the reflectivity of the optical information recording medium before and after irradiation is measured at an irradiation wavelength of 405 nm using a visible-ultraviolet spectrophotometer V-570 (supplied from JASCO Corporation, Japan).

It is difficult to accurately measure and evaluate the light resistance of an optical disc including a reflective film composed of silver or a silver alloy under the above-mentioned evaluation test condition, if a test piece to be tested includes a substrate typically of a polycarbonate, and a silver or silver alloy thin film alone arranged on the substrate (hereinafter also be referred to as “test piece without resin layer”). This is because this sectional structure of the sample differs from that of an optical disc practically used.

A practical optical disc has a sectional structure in which a silver or a silver alloy reflective film (or silver or a silver alloy semi-reflective film) and an ultraviolet-cured resin layer are arranged on a polycarbonate (hereinafter also briefly referred to as “PC”) substrate and are in contact with each other. When the silver alloy semi-reflective film or a silver alloy reflective film is in contact with the ultraviolet-cured resin layer, silver in the reflective film or the semi-reflective film may migrate into and aggregate in the ultraviolet-cured resin layer, resulting in deterioration. This is probably because silver in the reflective film or the semi-reflective film reacts with oxygen in the ultraviolet-cured resin layer.

Accordingly, if a test piece in an evaluation test is a test piece without resin layer including a substrate typically of a polycarbonate, and a silver alloy thin film alone arranged on the substrate, this test piece does not undergo deterioration due to migration and aggregation of silver into an ultraviolet-cured resin layer, because the test piece does not have such an ultraviolet-cured resin layer. Accordingly, the evaluation test condition using a known test piece without resin layer may fail to evaluate the resistance to moist heat and the light resistance accurately.

Other Evaluation Test Conditions

It is desirable to use an identical test piece of a sample optical information recording medium in these evaluation tests for the resistance to moist heat and the light resistance, for satisfactory reproducibility. A substrate for use in the tests is preferably the same substrate as that in an optical information recording medium (optical disc) in interest, for satisfactory reproducibility. This will be applied not only to the type of the substrate but also to the thickness and diameter thereof. For example, if the test is to be applied to a DVD, a polycarbonate substrate widely used in DVDs is preferably used, and its thickness and diameter may be a thickness of 0.6±0.03 mm and a diameter of 12.0±0.03 cm as with those generally used in DVDs.

An ultraviolet-cured resin layer to be in contact with the silver alloy reflective film and arranged on or above the silver alloy reflective film preferably includes the same resin as that of the ultraviolet-curable resin used in the target optical information recording medium (optical disc). This will be applied not only to the type of the ultraviolet-curable resin but also to the thickness of the layer. The thickness of the ultraviolet-cured resin layer may be, for example, a thickness of 55±15 μm, as with that of an ultraviolet-curable resin layer generally used in read-only DVDs each using a polycarbonate substrate.

Ultraviolet-Cured Resin Layer

An ultraviolet-cured resin layer for use according to an embodiment of the present invention has a content of a resin-derived organic component of 99 percent by mass or more. If the content of a resin-derived organic component in the ultraviolet-cured resin layer is less than 99 percent by mass, the proportion of a resin-derived organic component is insufficient as in the known optical disc. In the known optical disc, an ultraviolet-cured resin layer typically contains an ultraviolet-curable ink including a large amount of a pigment, for higher hardness and density of the ultraviolet-cured resin layer. With increasing contents of other components, such as pigments, than resin-derived organic components, the optical transparency essential for a resin layer of an optical information recording medium decreases, and the resulting optical information recording medium may be unsuitable for use as optical discs requiring optical transparency.

According to an embodiment of the present invention, the ultraviolet-cured resin layer is allowed to have a high hardness and a high density by incorporating an acrylic monomer and increasing the power of ultraviolet rays to be applied, in addition to increasing the resin purity in the ultraviolet-cured resin layer as mentioned above. Specifically, a resin layer after ultraviolet curing is allowed to have a high surface electrical resistance of 2.0×10¹³Ω or more, by incorporating an acrylic monomer into a resin composition before ultraviolet curing and thus converting the acrylic monomer into a cured resin in the resulting ultraviolet-cured resin layer. In addition, the resin layer after ultraviolet curing is allowed to have a high surface electrical resistance of 2.0×10¹³Ω or more, by applying ultraviolet rays at a high power to the resin composition to be cured upon ultraviolet irradiation.

When an acrylic monomer is three-dimensionally cross-linked, the resulting cross-linking density is remarkably high, because such an acrylic monomer includes a molecular chain of a half or less size as compared to that of an acrylic oligomer. This increases the hardness and surface electrical resistance of the resin layer after ultraviolet curing. For increasing the cross-linking density, it is also effective to increase the radiation intensity of ultraviolet rays for use in curing. An acrylic oligomer originally has plural functional groups which are activated upon irradiation of ultraviolet rays and cause cross-linking. If ultraviolet rays are applied at a low radiation intensity, the rays do not activate all the functional groups, resulting in a resin layer having a low cross-linking density. Conversely, it is effective to increase the intensity of ultraviolet rays to be applied, for activating functional groups of an acrylic oligomer which cause cross-linking.

This enables a high hardness and a high density of an ultraviolet-cured resin layer in an optical information recording medium and suppresses the deterioration due to migration and aggregation of silver from the silver alloy reflective film into the ultraviolet-cured resin layer. This therefore enables improvements or insurance of durability such as light resistance.

If an ultraviolet-cured resin layer has a surface electrical resistance less than 2.0×10¹³Ω, the ultraviolet-cured resin layer in an optical information recording medium may be insufficient in hardness and density, thereby failing to suppress deterioration due to migration and aggregation of silver from the silver alloy reflective film into the ultraviolet-cured resin layer. Accordingly, it may be difficult to improve or ensure durability such as light resistance.

Ultraviolet-Curable Resin Composition

A resin composition before ultraviolet curing for use in an embodiment of the present invention preferably may contain an acrylic oligomer, an acrylic monomer, and a polymerization initiator. The acrylic monomer and polymerization initiator may be commercially available products.

Acrylic Oligomer:

An acrylic oligomer is a main component in the ultraviolet-cured resin layer which acts as an adhesive layer and/or a protective layer in an optical information recording medium (optical disc). Examples of the acrylic oligomer include a co-oligomer of an acrylic monomer and a urethane monomer, a co-oligomer of an acrylic monomer and an epoxy monomer, and a co-oligomer of an acrylic monomer, a urethane monomer, and an epoxy monomer. Among them, preferred are polyfunctional acrylic oligomers each having six or more and tenor less acrylic functional groups. Preferred examples of such polyfunctional acrylic oligomers include aromatic urethane-acrylic oligomers and aliphatic urethane-acrylic oligomers.

Acrylic Monomer:

The acrylic monomer content of the resin composition before ultraviolet curing is generally from about 30 to about 99 percent by mass, and preferably from about 40 to about 70 percent by mass. Some acrylic oligomers originally contain about 30 percent by mass or less of an acrylic monomer. Accordingly, the term “acrylic monomer content” of a resin composition before ultraviolet curing as used herein refers to a total of the content of an acrylic monomer originally contained in an acrylic oligomer and the content of an acrylic monomer added to the resin composition. The acrylic monomer content should be set within such a range as to increase the surface electrical resistance of the resin layer after ultraviolet curing to 2.0×10¹³Ω or more.

Examples of acrylic monomers which are capable of accelerating a cross-linking reaction of the acrylic oligomer and thereby effectively increasing the hardness and hardness of a cured resin layer are illustrated below.

Examples of acrylic monomers having no functional group in side chain include methyl acrylate, ethyl acrylate, butyl acrylate, isobutyl acrylate, t-butyl acrylate, benzyl acrylate, cyclohexyl acrylate, 2-ethylhexyl acrylate, cetyl acrylate, lauryl acrylate, n-stearyl acrylate, isobornyl acrylate, 2-methoxyethyl acrylate, 3-methoxybutyl, ethoxydiethylene glycol acrylate, caprolactone-modified tetrahydrofurfuryl acrylate, diacrylate of caprolactone-modified hydroxypivalic acid neopentyl glycol ester, and tetrahydrofurfuryl acrylate.

Examples of acrylic monomers each having two or more double bonds per molecule include ethylene glycol diacrylate, diethylene glycol diacrylate, 1,4-butanediol diacrylate, 1,6-hexanediol diacrylate, tripropylene glycol diacrylate, trimethylolpropane triacrylate, trimethylolpropane ethylene oxide-modified (EO-modified) triacrylate, pentaerythritol triacrylate, diacrylate of neopentyl glycol hydroxypivalic acid ester, 1,9-nonanediol acrylate, dipentaerythritol pentaacrylate, dipentaerythritol hexaacrylate, acrylic-modified dipentaerythritol acrylate, EO-modified bisphenol-A diacrylate, acrylate of ε-caprolactone-modified dipentaerythritol, and 2-propenoic acid [2≡[1,1-dimethyl-2-[(1-oxo-2-propenyl)oxy]ethyl]-5-ethyl-1,3-dioxan-5-yl]methyl ester.

Examples of acrylic monomers each having a hydroxyl group in side chain include 2-hydroxyethyl acrylate, 2-hydroxypropyl acrylate, and 4-hydroxybutyl acrylate. Examples of acrylic monomers each having an acidic group in side chain include 2-hydroxypropyl acrylate adduct of phthalic anhydride. Examples of acrylic monomers each having a basic group in side chain include 2-dimethylaminoethyl acrylate and 2-diethylaminoethyl acrylate. Examples of acrylic monomers each having an epoxy group in side chain include glycidyl acrylate. Examples of acrylic monomers each having an ionic group in side chain include N,N,N-trimethyl-N-(2-hydroxy-3-acryloyloxypropyl)ammonium chloride.

Photo-Induced Polymerization Initiator:

The content of a photo-induced polymerization initiator in an ultraviolet-curable resin composition is generally from about 0.005 to about 5 percent by mass. Examples of such photo-induced polymerization initiator include ketone, benzoin, and thioxane photo-induced polymerization initiators. Examples of ketone photo-induced polymerization initiators include acetophenone and benzophenone. Examples of benzoin photo-induced polymerization initiators include benzoin and benzoin methyl ether. Examples of thioxane photo-induced polymerization initiators include thioxane and 2-methylthioxane.

Other Additives

An ultraviolet-curable resin composition may further contain any of other additives and resins for the purpose typically of ensuring storage stability, within such a range that the resulting ultraviolet-cured resin layer has a content of a resin-derived organic component of 99 percent by mass or more. Examples of usable additives include phenol compounds, amine compounds, sulfur compounds, and phosphorus compounds. In addition, the ultraviolet-curable resin composition may further contain, as high-molecular polymers, any of resins such as polyesters, polycarbonates, acrylic polymers, polyurethanes, and vinyl polymers. The resin composition may further contain, if necessary, any of organic solvents, as well as additives such as silane coupling agents, polymerization inhibitors, leveling agents, antistatics, surface lubricants, ultraviolet absorbers, and fillers.

Formation of Ultraviolet-Curable Resin Layer

The ultraviolet-curable resin composition is used for forming an adhesive layer and/or protective layer for an optical disc using silver or a silver alloy as a semi-transparent (semi-reflective) or total-reflective film. Specifically, the ultraviolet-curable resin composition may be applied to a silver or a silver alloy thin film (semi-reflective film or reflective film) on a polycarbonate substrate by any procedure such as spin coating, so-called 2P (photo-polymerization) process, roll coating, or screen printing. The application may be conducted so that an adhesive layer after bonding or a protective layer after formation has a thickness of about 1 to about 100 μm.

To carry out adhesion (bonding) for preparing a double-layer optical disc, ultraviolet or near-ultraviolet rays are applied from one or both sides of substrate, after bonding two optical disc substrates with each other or after forming one optical disc substrate to thereby cure the adhesive layer. The irradiance is preferably about 50 to about 1000 mJ/cm². The curing by irradiation with ultraviolet or near-ultraviolet rays can be carried out using any light source, as long as it can emit ultraviolet or near-ultraviolet rays. Examples of such light sources include low-pressure, high-pressure, and ultrahigh-pressure mercury lamps, metal halide lamps, (pulsed) xenon lamps, and electrodeless lamps.

Thickness of Silver or Silver Alloy Reflective Film

As a total-reflective film deposited on a substrate for use in an optical disc, a film of silver or a silver alloy may be deposited to a thickness of about 35 to about 60 nm on a polycarbonate substrate (hereinafter referred to as “PC substrate”) typically by sputtering. Likewise, as a semi-reflective film deposited on a substrate, a film of silver or a silver alloy may be deposited to a thickness of about 5 to about 20 nm on a PC substrate typically by sputtering.

Composition of Silver or Silver Alloy Reflective Film

A reflective film (reflective film or semi-reflective film) for use in an embodiment of the present invention includes, as its composition, silver (pure silver) or a silver alloy. A silver or silver alloy sputtering target for the deposition of the reflective film can be selected from among commercially available pure silver or silver alloy sputtering targets. Examples of commercially available silver alloy sputtering targets include a Ag-1.0 at. % Bi alloy sputtering target and a Ag-0.35 at. % Bi-0.2 at. % Nd alloy sputtering target both supplied from Kobelco Research Institute, Inc. (Japan).

The composition of the silver or silver alloy reflective film (reflective film or semi-reflective film), however, can be freely selected, and an appropriate sputtering target according to the selected composition can be prepared and used. In this connection, a silver alloy reflective film having an improved alloy composition so as to suppress deterioration due to migration and aggregation of silver from the silver alloy reflective film to the ultraviolet-cured resin layer can also be used herein, for improving durability of the silver alloy reflective film. In this case, a silver alloy as a sputtering target having a corresponding composition to deposit the reflective film can be used.

Deposition of Silver Alloy Reflective Film

A silver alloy reflective film for use in an embodiment of the present invention may be deposited by subjecting a silver alloy sputtering target to sputtering to a substrate such as a PC substrate. In this sputtering, the sputtering target preferably includes a silver alloy having a composition within the same range as that of the target silver reflective film, so as to easily deposit a silver reflective film having the desired composition.

If possible, a silver reflective film having the desired composition may be obtained as a result of deposition using two or more sputtering targets containing silver and alloy elements, respectively, or those each containing silver and alloy elements.

The sputtering or vapor deposition can be carried out according to a procedure known and generally used as a deposition procedure of thin films. However, direct-current (DC) magnetron sputtering is preferred for higher deposition stability.

A sputtering target to be used can be prepared, for example, by melting a silver alloy, or pure metals or alloys containing silver Ag and alloy elements such as Bi, W, Ti, V, Mn, Zr, Cr, and/or Ni, and subjecting the molten metal to casting into an appropriate shape such as a plate or sheet, or subjecting the molten metal to powder metallurgy or an ingot technique such as spray forming into an appropriate shape such as a plate or sheet.

### EXAMPLES

The present invention will be illustrated in further detail with reference to several examples below, which, however, are not limitative at all. A silver alloy thin film was deposited on a polycarbonate resin substrate by DC magnetron sputtering. An ultraviolet-cured resin layer was applied to the silver alloy thin film to yield a single-layer tested optical information recording medium. In addition, two plies of the resulting article including the substrate, the silver alloy thin film, and the ultraviolet-cured resin layer were bonded to yield a double-layer tested optical information recording medium. In this manner, a series of tested optical information recording media was prepared, and they were subjected to tests for evaluating durability. The results are shown in Tables 1 to 4.

The content (proportion) of a resin-derived organic component in the ultraviolet-cured resin layer was adjusted to be 99 percent by mass or more. The surface electrical resistance of the resin layers after ultraviolet curing of the tested optical information recording media was adjusted by controlling the content of an acrylic monomer to be added to the ultraviolet-curable resin composition and the after-mentioned curing conditions such as power and irradiation period of a light source for applying ultraviolet rays.

Layer Structure of Single-Layer Optical Information Recording Media:

Tested optical information recording media of single-layer type each have a layer structure of [protective layer (UV-cured layer)]/[silver alloy reflective film]/[PC (polycarbonate) substrate]. Initially, a silver alloy reflective film was deposited to an average thickness of 15 nm on a PC (polycarbonate) substrate, and an ultraviolet-curable resin was applied to the silver alloy reflective film by spin coating. Radiation including ultraviolet rays was applied to cure the ultraviolet-curable resin to yield an ultraviolet-cured resin layer having an average thickness of 50 μm (micrometers).

Layer Structure of Tested Double-Layer Optical Information Recording Media:

Tested optical information recording media of single-layer type each have a layer structure of PC/[silver alloy semi-reflective film]/[adhesive layer (UV-cured layer)]/[silver alloy reflective film]/PC. In these media, the reflective film and the semi-reflective film had the same composition as each other. The media were prepared in the following manner. Initially, a silver alloy reflective film was deposited to an average thickness of 15 nm on a PC substrate. In addition, a silver alloy semi-reflective film was deposited on another PC substrate. An ultraviolet-curable resin was applied to the silver alloy reflective film by spin coating, and the resulting layer of ultraviolet-curable resin was applied to the silver alloy semi-reflective film deposited on the PC substrate. Radiation including ultraviolet rays was then applied to cure the resin to there by yield an ultraviolet-cured resin layer having an average thickness of 50 μm (micrometers).

Reflective Film in Single- And Double-Layer Structures, and Semi-Reflective Film in Double-Layer Structure:

The reflective films and the semi-reflective films were deposited using silver alloy sputtering targets having the component compositions in Tables 1 to 4. Specifically, deposition was carried out using a Ag-1.0 at. % Bi alloy sputtering target and a Ag-0.35 at. % Bi-0.2 at. % Nd alloy sputtering target, respectively, supplied from Kobelco Research Institute, Inc. (Japan). In addition, silver alloy reflective films having the above-mentioned preferred compositions were prepared by subjecting corresponding silver alloy target to an ingot technique. The deposited films have substantially the same compositions as those of sputtering targets, except that the deposited silver alloy reflective films have slightly lower Bi contents than those of the sputtering targets, because bismuth (Bi) may be lost to some extent during sputtering.

Sputtering Condition:

The deposition of the silver alloy thin films in respective samples was carried out using a DC magnetron sputtering apparatus supplied from Oerlikon (former Unaxis) under the trade name of Cube Star under common sputtering conditions of a substrate temperature of 22° C., an Ar gas pressure of 2 mTorr, a deposition power density of 1 W/cm², and a back pressure of 5×10⁻⁶ Torr or less.

A polycarbonate substrate having a thickness of 0.6 mm and a diameter of 12 cm was used in common in respective samples.

Ultraviolet-Curable Resin Composition:

The ultraviolet-curable resin compositions to be applied to the silver alloy reflective films by spin coating had been prepared by adding a commercially available acrylic monomer to commercially available mixtures A, B, and C each containing an acrylic oligomer and a polymerization initiator. These mixtures originally contained 20 percent by mass or more of an acrylic monomer. The amounts of the added acrylic monomer (contents of additional acrylic monomer) are shown in Tables 1 to 4. The total contents of acrylic monomers in the actual ultraviolet-curable resin compositions are larger than the amounts of added acrylic monomer in Tables 1 to 4. Each of the total contents is a total sum of the amount of added acrylic monomer and the acrylic monomer content originally contained in the mixture of an acrylic oligomer and a polymerization initiator. Samples without the addition of an acrylic monomer were also subjected to tests. In Tables 1 to 4, data with “-” in the amount of added acrylic monomer are data of samples without the addition of the commercially available acrylic monomer.

The samples without the addition of the acrylic monomer showed a surface electrical resistance of the cured resin within a range of from 0.4×10¹³Ω to 1.6×10¹³Ω. In contrast, samples with the addition of the acrylic monomer showed a surface electrical resistance of the cured resin within a range of from 5.6×10¹³Ω to 12.9×10¹³Ω. Even without the addition of the acrylic monomer, samples cured by ultraviolet irradiation at an increased power showed a surface electrical resistance of the cured resin within a range of from 2.4×10¹³Ω to 4.6×10¹³Ω.

In Tables 1 to 4, the mixture “A” of an acrylic oligomer and a polymerization initiator was a mixture supplied from Dainippon Ink & Chemicals, Inc. (Japan) under the trade name of SD 694; the mixture “B” of an acrylic oligomer and a polymerization initiator was a mixture of an acrylic oligomer and a polymerization initiator supplied from Nippon Kayaku Co., Ltd. (Japan) under the trade name of DVD 617; and the mixture “C” of an acrylic oligomer and a polymerization initiator was a mixture of an acrylic oligomer and a polymerization initiator supplied from Sony Chemical & Information Device Corporation (Japan) under the trade name of SK 6500.

As the acrylic monomer, dipentaerythritol hexaacrylate (DPHA), a polyfunctional acrylate monomer, supplied from Sigma-Aldrich, Inc. was used.

Resin Curing Condition upon Irradiation with Radiation (Ultraviolet Rays):

The light source power was controlled by adjusting the height of a mercury lamp. As the light source power, the illuminance was measured at the position of a tested disc. Regarding the “light source power” in Tables 1 to 4, “regular” indicates an illuminance of 100 mW/cm², “highpower” indicates an illuminance of 150 mW/cm², and “low power” indicates an illuminance of 50 mW/cm². Regarding the “Irradiation Period”, “regular” indicates 40 seconds, “half” indicates 27 seconds, and “twice” indicates 80 seconds.

Resin Layer After Ultraviolet Curing:

The contents of a resin-derived organic component in the resin layer after ultraviolet curing in the samples were each 99 percent by mass or more. The contents of a resin-derived organic component in the resin layer after ultraviolet curing were determined by a combustion method. Specifically, a resin after ultraviolet curing was sampled and weighed, the sampled resin was then placed in a crucible, heated using a gas burner, and the residue including non-organic components alone was weighed. The proportion (content) of a resin-derived organic component in the resin layer after ultraviolet curing was calculated based on the initial weight and the weight of the residue.

Measurement of Surface Electrical Resistance of Resin Layer After Ultraviolet Curing:

The measurement was carried out according to the method specified in ASTM D257 using a digital ultra-high-resistance/microammeter R8340A supplied from Advantest Corporation (Japan) as a measuring system with a URS probe MCP-HTP14 (17.8 mm in diameter) supplied from Mitsubishi Chemical Corporation. The measurement was conducted at an applied voltage of 100 V (direct current), a testing temperature of temperature of 23±2° C., and a testing humidity of 50±5% relative humidity (RH) for an application period of 1 minute.

Durability (Light Resistance):

As an index of durability, the light resistance of a tested optical information recording medium was measured. Specifically, the loss (%) in reflectivity after the irradiation of the tested optical information recording medium was measured under the following conditions and method. The loss in reflectivity (decrease in reflectivity between before and after the irradiation, in unit of percentage) was evaluated as follows. A sample having a loss in reflectivity of 1.5% or less was evaluated to have “Excellent” durability, and a sample having a loss in reflectivity of more than 1.5% and 3.0% or less was evaluated to have “Good” durability. Samples evaluated to have “Excellent” or “Good” durability were evaluated to be passed in the test. A sample having a loss in reflectivity of more than 3% was evaluated to have “Poor” durability and to be failed in the test. These results are also shown in Tables 1 to 4.

In Examples 1 to 36 having a single-layer structure or double-layer structure in Tables 1 and 2, the ultraviolet-cured resin layer contains an ultraviolet-cured resin of an acrylic monomer, this ultraviolet-cured resin layer has a content of a resin-derived organic component of 99 percent by mass or more and has a surface electrical resistance of 2.0×10¹³Ω or more.

As a result, these Examples 1 to 36 as tested optical information recording media have such durability as to have a loss in reflectivity of 3% or less after irradiation, in which the irradiation was carried out by applying radiation from a fluorescent lamp having a color temperature of 6700 K to the optical information recording medium at a distance of 60 mm at a temperature of 25° C. for 100 hours.

In contrast, Comparative Examples 37 to 60 having a single-layer structure or double-layer structure in Tables 3 and 4 corresponding to Examples 1 to 36 in Tables 1 and 2 contain an insufficient amount of an acrylic monomer or have been cured under conditions in which a certain parameter such as power of light source or irradiation period is insufficient, although they have a content of a resin-derived organic component in the ultraviolet-cured resin layer of 99 percent by mass or more.

Accordingly, their ultraviolet-cured resin layer has a surface electrical resistance less than the lower limit of 2.0×10¹³Ω, and they are insufficient in hardness and/or density. As a result, Comparative Examples 37 to 60 as tested optical information recording media have such durability as to have a loss in reflectivity markedly exceeding 3% upon irradiation with ultraviolet rays of a wavelength of 405 nm. Consequently, Comparative Examples 37 to 60 have much inferior durability to that of Examples 1 to 36.

These results demonstrate that the surface electrical resistance of the ultraviolet-cured resin layer and other preferred conditions as specified according to an embodiment of the present invention contribute to improvements or insurance in durability of optical information recording media.

TABLE 1
Single-Layer Structure

| | | Tested optical information recording medium | | | | | | | |
|---|---|---|---|---|---|---|---|---|---|
| | | | Ultraviolet-cured resin layer | | | | Properties | | |
| | | Ag alloy sputtering | | Amount | | | Surface | | |
| | | target composition | | of added acrylic | | | resistivity | | |
| | | (atomic percent, with | Resin | monomer | Curing light | Irradiation | of resin layer | Loss | |
| Category | No. | the residue being Ag) | composition | (mass %) | source power | period (sec) | (10¹³ Ω) | in reflectivity (%) | Durability |
| Example | 1 | Ag—1.0Bi | A | 30 | regular | regular | 8.7 | 0.9 | Excellent |
| | 2 | Ag—0.35Bi—0.2Nd | A | 30 | regular | regular | 8.5 | 1.7 | Good |
| | 3 | Ag—1.0Bi | A | — | high power | half | 4.6 | 1.6 | Good |
| | 4 | Ag—0.35Bi—0.2Nd | A | — | high power | half | 4.8 | 2.2 | Good |
| | 5 | Ag—1.0Bi | A | 30 | high power | half | 12.9 | 0.5 | Excellent |
| | 6 | Ag—0.35Bi—0.2Nd | A | 30 | high power | half | 12.1 | 1.2 | Good |
| | 7 | Ag—1.0Bi | B | 30 | regular | regular | 7.4 | 1.1 | Good |
| | 8 | Ag—0.35Bi—0.2Nd | B | 30 | regular | regular | 7.7 | 0.8 | Excellent |
| | 9 | Ag—1.0Bi | B | — | high power | half | 4.2 | 1.7 | Good |
| | 10 | Ag—0.35Bi—0.2Nd | B | — | high power | half | 4.0 | 2.1 | Good |
| | 11 | Ag—1.0Bi | B | 30 | high power | half | 11.1 | 0.6 | Excellent |
| | 12 | Ag—0.35Bi—0.2Nd | B | 30 | high power | half | 11.6 | 1.5 | Good |
| | 13 | Ag—1.0Bi | C | 30 | regular | regular | 5.6 | 1.3 | Good |
| | 14 | Ag—0.35Bi—0.2Nd | C | 30 | regular | regular | 5.3 | 1.9 | Good |
| | 15 | Ag—1.0Bi | C | — | high power | half | 2.4 | 1.8 | Good |
| | 16 | Ag—0.35Bi—0.2Nd | C | — | high power | half | 2.2 | 2.3 | Good |
| | 17 | Ag—1.0Bi | C | 30 | high power | half | 7.1 | 0.7 | Excellent |
| | 18 | Ag—0.35Bi—0.2Nd | C | 30 | high power | half | 7.9 | 1.8 | Good |

TABLE 2
Double-Layer Structure

| | | Tested optical information recording medium | | | | | | | |
|---|---|---|---|---|---|---|---|---|---|
| | | | Ultraviolet-cured resin layer | | | | Properties | | |
| | | Ag alloy sputtering | | Amount | | | Surface | | |
| | | target composition | | of added acrylic | | | resistivity | | |
| | | (atomic percent, with | Resin | monomer | Curing light | Irradiation | of resin layer | Loss | |
| Category | No. | the residue being Ag) | composition | (mass %) | source power | period (sec) | (10¹³ Ω) | in reflectivity (%) | Durability |
| Example | 19 | Ag—1.0Bi | A | 30 | regular | regular | 8.7 | 1.8 | Good |
| | 20 | Ag—0.35Bi—0.2Nd | A | 30 | regular | regular | 8.8 | 2.2 | Good |
| | 21 | Ag—1.0Bi | A | — | high power | half | 4.3 | 1.8 | Good |
| | 22 | Ag—0.35Bi—0.2Nd | A | — | high power | half | 4.2 | 2.5 | Good |
| | 23 | Ag—1.0Bi | A | 30 | high power | half | 12.1 | 1.9 | Good |
| | 24 | Ag—0.35Bi—0.2Nd | A | 30 | high power | half | 12.7 | 1.8 | Good |
| | 25 | Ag—1.0Bi | B | 30 | regular | regular | 7.5 | 1.5 | Good |
| | 26 | Ag—0.35Bi—0.2Nd | B | 30 | regular | regular | 7.3 | 2.2 | Good |
| | 27 | Ag—1.0Bi | B | — | high power | half | 3.9 | 1.9 | Good |
| | 28 | Ag—0.35Bi—0.2Nd | B | — | high power | half | 4.3 | 2.8 | Good |
| | 29 | Ag—1.0Bi | B | 30 | high power | half | 10.4 | 1.8 | Good |
| | 30 | Ag—0.35Bi—0.2Nd | B | 30 | high power | half | 10.8 | 2.8 | Good |
| | 31 | Ag—1.0Bi | C | 30 | regular | regular | 4.1 | 2.3 | Good |
| | 32 | Ag—0.35Bi—0.2Nd | C | 30 | regular | regular | 4.6 | 1.7 | Good |
| | 33 | Ag—1.0Bi | C | — | high power | half | 2.4 | 1.9 | Good |
| | 34 | Ag—0.35Bi—0.2Nd | C | — | high power | half | 2.2 | 2.9 | Good |
| | 35 | Ag—1.0Bi | C | 30 | high power | half | 5.5 | 1.7 | Good |
| | 36 | Ag—0.35Bi—0.2Nd | C | 30 | high power | half | 5.3 | 2.2 | Good |

TABLE 3
Single-Layer Structure

| | | Tested optical information recording medium | | | | | | | |
|---|---|---|---|---|---|---|---|---|---|
| | | | Ultraviolet-cured resin layer | | | | Properties | | |
| | | Ag alloy sputtering | | Amount | | | Surface | | |
| | | target composition | | of added acrylic | | | resistivity | | |
| | | (atomic percent, with | Resin | monomer | Curing light | Irradiation | of resin layer | Loss | |
| Category | No. | the residue being Ag) | composition | (mass %) | source power | period (sec) | (10¹³ Ω) | in reflectivity (%) | Durability |
| Com. Ex. | 37 | Ag—1.0Bi | A | — | regular | regular | 1.1 | 3.8 | Poor |
| | 38 | Ag—0.35Bi—0.2Nd | A | — | regular | regular | 1.6 | 6.9 | Poor |
| | 39 | Ag—1.0Bi | A | — | low power | twice | 0.2 | 7.0 | Poor |
| | 40 | Ag—0.35Bi—0.2Nd | A | — | low power | twice | 0.1 | 9.2 | Poor |
| | 41 | Ag—1.0Bi | B | — | regular | regular | 0.5 | 5.4 | Poor |
| | 42 | Ag—0.35Bi—0.2Nd | B | — | regular | regular | 0.4 | 7.3 | Poor |
| | 43 | Ag—1.0Bi | B | — | low power | twice | 0.03 | 9.0 | Poor |
| | 44 | Ag—0.35Bi—0.2Nd | B | — | low power | twice | 0.08 | 10.2 | Poor |
| | 45 | Ag—1.0Bi | C | — | regular | regular | 0.3 | 6.8 | Poor |
| | 46 | Ag—0.35Bi—0.2Nd | C | — | regular | regular | 0.4 | 8.2 | Poor |
| | 47 | Ag—1.0Bi | C | — | low power | twice | 0.08 | 8.9 | Poor |
| | 48 | Ag—0.35Bi—0.2Nd | C | — | low power | twice | 0.03 | 10.8 | Poor |

TABLE 4
Double-Layer Structure

| | | Tested optical information recording medium | | | | | | | |
|---|---|---|---|---|---|---|---|---|---|
| | | | Ultraviolet-cured resin layer | | | | Properties | | |
| | | Ag alloy sputtering | | Amount | | | Surface | | |
| | | target composition | | of added acrylic | | | resistivity | | |
| | | (atomic percent, with | Resin | monomer | Curing light | Irradiation | of resin layer | Loss | |
| Category | No. | the residue being Ag) | composition | (mass %) | source power | period (sec) | (10¹³ Ω) | in reflectivity (%) | Durability |
| Com. Ex. | 49 | Ag—1.0Bi | A | — | regular | regular | 0.7 | 4.3 | Poor |
| | 50 | Ag—0.35Bi—0.2Nd | A | — | regular | regular | 0.8 | 6.5 | Poor |
| | 51 | Ag—1.0Bi | A | — | low power | twice | 0.1 | 7.1 | Poor |
| | 52 | Ag—0.35Bi—0.2Nd | A | — | low power | twice | 0.2 | 9.7 | Poor |
| | 53 | Ag—1.0Bi | B | — | regular | regular | 0.5 | 6.0 | Poor |
| | 54 | Ag—0.35Bi—0.2Nd | B | — | regular | regular | 0.7 | 6.3 | Poor |
| | 55 | Ag—1.0Bi | B | — | low power | twice | 0.02 | 9.9 | Poor |
| | 56 | Ag—0.35Bi—0.2Nd | B | — | low power | twice | 0.02 | 11.6 | Poor |
| | 57 | Ag—1.0Bi | C | — | regular | regular | 0.23 | 7.5 | Poor |
| | 58 | Ag—0.35Bi—0.2Nd | C | — | regular | regular | 0.21 | 7.4 | Poor |
| | 59 | Ag—1.0Bi | C | — | low power | twice | 0.04 | 9.5 | Poor |
| | 60 | Ag—0.35Bi—0.2Nd | C | — | low power | twice | 0.05 | 11.0 | Poor |

According to an embodiment of the present invention, there is provided an optical information recording medium which is excellent in durability and ensures improvements in durability. It is therefore suitable and useful as an optical information recording medium requiring such durability.

While preferred embodiments have been described, it should be understood by those skilled in the art that various modifications, combinations, subcombinations, and alterations may occur depending on design requirements and other factors insofar as they are within the scope of the appended claims or the equivalents thereof.

What is claimed is:

1. An optical information recording medium, comprising:
at least one substrate;
at least one thin film containing silver or a silver alloy; and
an ultraviolet-cured resin layer,
the at least one thin film and the ultraviolet-cured resin layer being in contact with each other and being arranged on or above the at least one substrate,
wherein the ultraviolet-cured resin layer contains a cured resin of at least one acrylic monomer cured by the action of ultraviolet rays,
wherein the ultraviolet-cured resin layer has a content of a resin-derived organic component of 99 percent by mass or more, and
wherein the ultraviolet-cured resin layer has a surface electrical resistance of 2.0×10¹³Ω or more.

2. The optical information recording medium according to claim 1,
wherein the optical information recording medium has such durability as to have a loss in reflectivity after irradiation of 3% or less,
wherein the irradiation is carried out by applying radiation from a fluorescent lamp having a color temperature of 6700 K to a test piece at a distance of 60 mm at a temperature of 25° C. for 100 hours, and
wherein the test piece has substantially the same layer structure as that of the optical information recording medium.
